(19) United States
(12) Patent Application Publication
(10) Pub. No.: US 2009/0083295 A1
(43) Pub. Date: Mar. 26, 2009

(54) APPARATUS, COMPUTER PROGRAM PRODUCT, AND METHOD FOR MANAGING META DATA

(75) Inventors: Noriko Minamino, Tokyo (JP); Yasutaka Ohdake, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/235,632

(22) Filed: Sep. 23, 2008

(30) Foreign Application Priority Data
Sep. 26, 2007 (JP) 2007-249019

(51) Int. Cl. G06F 17/30

(52) U.S. Cl. 707/100; 707/E17.044

(57) ABSTRACT

In the case where specifics of an error have been detected out of an instance data that has been received by a receiving unit and that does not satisfy restrictions being applied to an instance data description and being defined in a dictionary that is meta data, a change proposal that has been created based on the specifics of the error and suggests a change that can be made on the dictionary is presented onto a dictionary editor terminal, based on dictionary change rules each of which defines, in the manner of a rule, a change that can be made on the dictionary in correspondence with an error pattern that is found during the instance data description. It is therefore possible to eliminate disparity between instance data editors and dictionary editors and to improve the quality of instance data.

### CROSS-REFERENCE TO RELATED APPLICATIONS

This application is based upon and claims the benefit of priority from the prior Japanese Patent Application No. 2007-249019, filed on Sep. 26, 2007; the entire contents of which are incorporated herein by reference.

### BACKGROUND OF THE INVENTION

1. Field of the Invention

The present invention relates to an apparatus, a computer program product, and a method for managing meta data.

2. Description of the Related Art

Hierarchical databases, like Object-Oriented Databases (OODBs) and Object-Relational Databases (ORDBs), each have a hierarchical structure in which subordinate categories inherit the attributes of their superordinate category. In such a hierarchical database, the number of attributes progressively increases for the subordinate categories due to the inheritance of the attributes. A subordinate category's inheriting the attributes of its subordinate category is generally referred to as “inheritance”.

In an object-oriented database, each of the categories in the hierarchical levels is often referred to as a “class”. In an object relational database (ORDB), each of the tables that are allowed to be inherited corresponds to a class. Between two tables having a superordinate-subordinate relationship, attributes are inherited from the superordinate table to the subordinate table. In other words, the header information of the columns in the superordinate table is inherited to the subordinate table. Pieces of data that respectively belong to the categories in a hierarchical level and have mutually the same type of attribute are referred to as “instances”. A set of instances is referred to as a “population” of data. In a relational database (RDB) or in an ORDB, a population of data is usually stored in a structure called a “table”. A row of attributes included in a table is referred to as a “header” of the table.

An example of a hierarchical database is International Organization for Standardization (ISO) 13584 Parts Library standard (hereinafter, the “PLIB standard”), which is an international standard for implementing an electronic catalogue system that electronically provides information of products. The PLIB standard is an international standard that is made up of a plurality of “Parts” and defines an object-oriented method for writing library data of products or parts as well as the semantics for the exchange file format. In other words, the PLIB standard defines what terms, what description method, and what data type are used. Part 42 of the “PLIB” standard has the same contents as International Electrotechnical Commission (IEC) 61360-2 (Part 2). The PLIB standard is a system for categorizing products in an object-oriented manner, defining the attributes with which each of the categories is characterized, and exchanging files with respect to the contents for the categories. Needless to say, the concept of inheriting attributes is included in the system. Also, the PLIB standard is made by making reference to ISO 6523 “Structure for the identification of organizations and organization parts”. In particular, by utilizing the International Code Designator (ICD) defined in ISO 6523, it is possible to assign a world-wide unique identifier to each of the attributes.

In recent years, a number of systems that are compliant with the “PLIB” standard have been proposed (cf. JP-A 2004-177996 (KOKAI) and JP-A 2004-178015 (KOKAI)).

Categories (i.e., classes) and attributes (i.e., properties) that are necessary when the product data is written are collectively referred to as a “dictionary”. Examples of international standard dictionaries that are compliant with the “PLIB” data model include ISO 13584-501 related to measuring instruments, ISO 13584-511 related to fasteners (e.g., screws), and IEC 61360-4 related to electric and electronic products. In Japan, ECALS dictionary and JeMarche dictionary are examples of standard dictionaries in the industrial field and are used for exchanging the specification data of products. Also, in other countries of the world, dictionaries are actively being developed.

Dictionary maintenance and management organizations maintain and manage the international standard dictionaries as described above by using a mechanism such as Registration Authority (RA) or Maintenance Agency (MA). The dictionary maintenance and management organizations receive suggestions for corrections from members in and out of the organizations and update the dictionaries after the suggestions for corrections are approved by, for example, a majority vote. The standard dictionaries in the industrial field are also maintained and managed by using a similar mechanism.

Generally speaking, instance data editors who write product data (hereinafter, “instance data”) by using dictionaries are different from dictionary editors who create, maintain, and manage dictionaries. As for the definitions in a dictionary, it is often the case that there is a disparity between the dictionary editor's understanding thereof and the instance data editor's understanding thereof. For example, the instance data editor may find that the definitions in the dictionary provided by the dictionary editor are not sufficient and may feel like he/she does not know what should be written in what way. As another example, the instance data editor may not be able to write what the dictionary editor has had in his/her mind. As yet another example, the definitions in the dictionary may not be regarded appropriate when the instance data editor writes the actual product data by using them.

The disparity between the dictionary editor and the instance data editor with respect to their understanding of the definitions in the dictionary prevents the product data from being written properly and also immediately brings about deterioration in quality of the product data.

### SUMMARY OF THE INVENTION

According to one aspect of the present invention, a meta data management apparatus includes a dictionary storing unit that stores a dictionary that is meta data defining a schema including a restriction of an instance data description; a rule storing unit that stores dictionary change rules each of which defines, in a manner of a rule, a change of the dictionary in correspondence with an error pattern of the instance data description; a receiving unit that receives an instance data described according to the schema via an Instance data editor terminal used by an editor of the instance data; an error detecting unit that detects specifics of an error when the instance data received by the receiving unit does not satisfy the restriction of the instance data description; and a suggestion presenting unit that presents a change proposal for dictionary (hereinafter, the “dictionary change proposal”) to a dictionary editor terminal used by a dictionary editor, the dictionary change proposal suggesting the change of the dictionary created based on the specifics of the error and one of the dictionary change rules corresponding to the specifics of the error.

According to another aspect of the present invention, a meta data management method includes receiving an instance data described according to a schema that is defined in a dictionary being the meta data and includes a restriction of an instance data description, via an instance data editor terminal used by an editor of the instance data; detecting specifics of an error from the received instance data, when the received instance data does not satisfy the restriction of the instance data description; and presenting a dictionary change proposal to a dictionary editor terminal used by a dictionary editor, the dictionary change proposal suggesting a change of the dictionary created from the specifics of the error, based on a dictionary change rule which defines, in a manner of a rule, the change of the dictionary corresponding to an error pattern of the instance data description.

A computer program product according to still another aspect of the present invention causes a computer to perform the method according to the present invention.

### BRIEF DESCRIPTION OF THE DRAWINGS

FIG. 1 is a schematic drawing of an example of a system structure of a meta data management system according to an embodiment of the present invention;

FIG. 2 is a module diagram of a server or each of clients;

FIG. 3 is a block diagram of functions of the meta data management system;

FIG. 4 is a schematic drawing of an example of a dictionary;

FIG. 5 is a schematic drawing of an example of a set of dictionary version control rules;

FIG. 6 is a front view of an example used for displaying an error;

FIG. 7 is a front view of another example used for displaying an error;

FIG. 8 is a schematic drawing of an example of specifics of an error;

FIG. 9 is a front view of an example used for displaying dictionary change proposal s;

FIG. 10 is a front view of another example used for displaying dictionary change proposal s;

FIG. 11 is a front view of yet another example used for displaying a dictionary change proposal;

FIG. 12 is a front view of an example used for displaying an annotation;

FIG. 13 is a front view of an example used for displaying a message to inform a recovery from an error;

FIG. 14 is a flowchart of a procedure in an instance data editing process; and

FIG. 15 is a flowchart of a procedure in a dictionary change proposal presenting process.

### DETAILED DESCRIPTION OF THE INVENTION

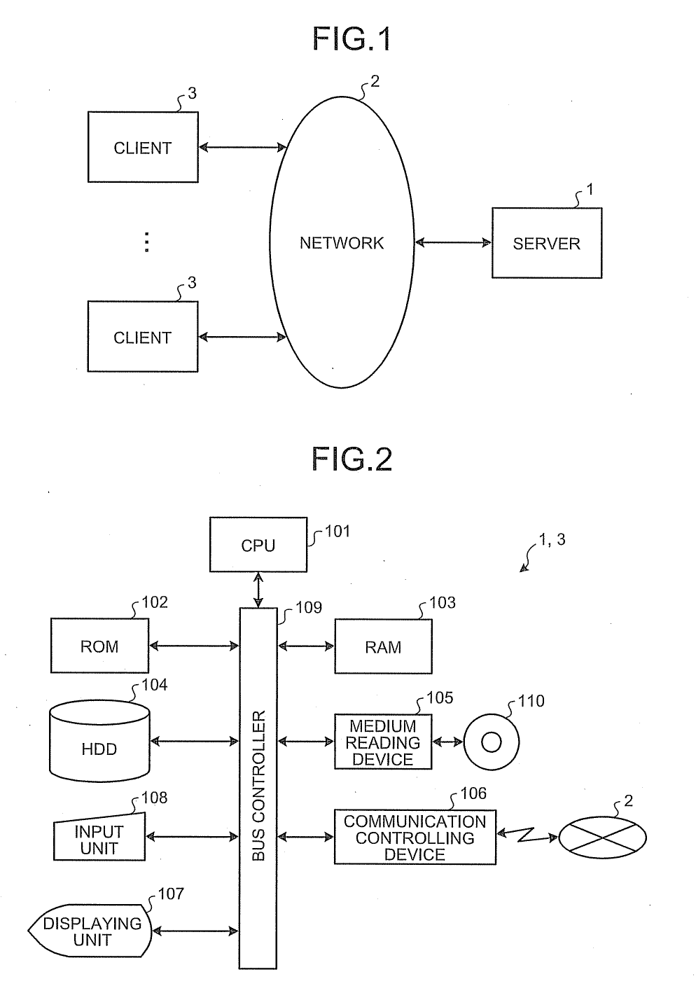

Exemplary embodiments of the present invention will be explained with reference to FIGS. 1 to 15. In the exemplary embodiments, a server computer is used as a meta data management apparatus.

FIG. 1 is a schematic drawing of an example of a system structure of a meta data management system according to an embodiment of the present invention. As shown in FIG. 1, the meta data management system is assumed to be a server-client system in which a plurality of client computers (hereinafter, the “clients”) 3 are connected to a server computer (hereinafter, the “server”) 1 via a network 2 like a Local Area Network (LAN). The server 1 and the clients 3 are each a commonly-used personal computer.

FIG. 2 is a module diagram of the server 1 or each of the clients 3. The server 1 and the clients 3 are each configured so as to include: a Central Processing Unit (CPU) 101 that performs information processing; a Read Only Memory (ROM) 102 that stores therein a Basic Input/Output System (BIOS) and the like; a Random Access Memory (RAM) 103 that stores therein various types of data in a rewritable manner; a Hard Disk Drive (HDD) 104 that functions as various types of databases and also serves as a storage unit storing therein various types of programs; a medium reading device 105 such as a Compact Disc Read-Only Memory (CD-ROM) drive used for storing information, distributing information to the outside of the server 1 or the client 3, and obtaining information from the outside of the server 1 or the client 3, via a storage medium 110; a communication controlling device 106 that transmits and receives information to and from other computers on the outside of the server 1 or the client 3 through communication via the network 2; a displaying unit 107 such as a Cathode Ray Tube (CRT) or a Liquid Crystal Display (LCD) that displays progress and results of processing to an operator of the server 1 or the client 3; and an input unit 108 that is a keyboard and/or a pointing device like a mouse used by the operator for inputting instructions and information to the CPU 101. The server 1 and the clients 3 each operate while a bus controller 109 arbitrates the data transmitted and received among these functional units.

In the server 1 and each of the clients 3, when the operator turns on the electric power, the CPU 101 runs a program that is called a loader and is stored in the ROM 102. A program that is called an Operating System (OS) and that manages hardware and software of the computer is read from the HDD 104 into the RAM 103 so that the OS is activated. The OS runs other programs, reads information, and stores information, according to an operation by the operator. Typical examples of an OS that are conventionally known include Windows (registered trademark). Operation programs that run on such an OS are called application programs. Application programs include not only programs that operate on a predetermined OS, but also programs that cause an OS to take over execution of a part of various types of processes described later, as well as programs that are contained in a group of program files that constitute predetermined application software or an OS.

In the server 1, a meta data management program is stored in the HDD 104, as an application program. In this regard, the HDD 104 functions as a storage medium that stores therein the meta data management program.

On the other hand, in each of the clients 3, an editing processing program is stored in the HDD 104, as an application program. In this regard, the HDD 104 functions as a storage medium that stores therein the editing processing program.

Also, generally speaking, the application programs to be installed in the HDD 104 included in the server 1 and each of the clients 3 can be recorded in one or more storage media 110 including various types of optical disks such as CD-ROMs and Digital Versatile Disks (DVDs), various types of magneto optical disks, various types of magnetic disks such as flexible disks, and media that use various methods such as semiconductor memories, so that the operation programs recorded on the storage media 110 can be installed into the HDD 104. Thus, storage media 110 that are portable, like optical information recording media such as CD-ROMs and magnetic media such as Floppy Disks (FDs), can also be each used as a storage medium for storing therein the application programs. Further, it is also acceptable to install the application programs into the HDDs 104 after obtaining the application programs from an external source via, for example, the communication controlling device 106.

In the server 1, when the meta data management program that operates on the OS is run, the CPU 101 performs various types of computation processes and controls the functional units in an integrated manner, according to the meta data management program. On the other hand, in each of the clients 3, when the editing processing program that operates on the OS is run, the CPU 101 performs various types of computation processes and controls the functional units in an integrated manner, according to the editing processing program. Of the various types of computation processes performed by the CPU 101 included in the server 1 and each of the clients 3, characteristic processes according to the present embodiment will be explained below.

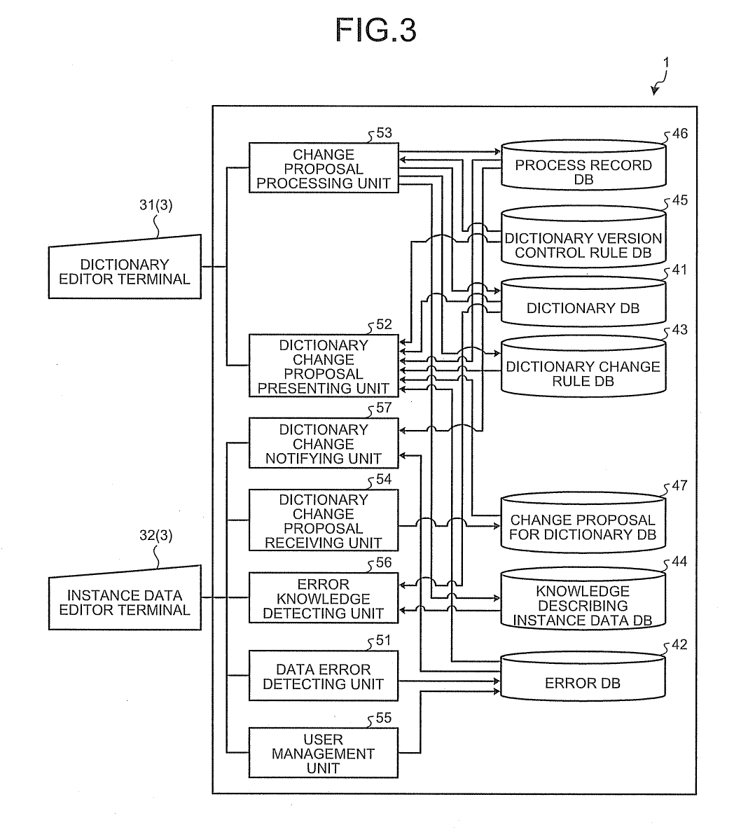

By following the editing processing program, each of the clients 3 outputs, via a Graphic User Interface (GUI), data received from the server 1 to the displaying unit 107. Each of the clients 3 also receives, via the GUI, data and commands based on operations and settings that have been performed and configured by the operator via the input unit 108 on screens displayed on the displaying unit 107, and further transmits the received data and commands to the server 1. The editing processing program achieves various types of functions according to the authority granted to each operator. As explained in detail later, by following the editing processing program, each of the clients 3 according to the present embodiment functions, according to the authority granted to each operator, as a dictionary editor terminal 31 that is to be used by a dictionary editor and edits dictionaries or an instance data editor terminal 32 that is to be used by an instance data editor and accepts inputs of created instance data, as shown in FIG. 3.

On the other hand, as shown in FIG. 3, the server 1 functions as a meta data management apparatus by following the meta data management program. The server 1 includes: a dictionary database (DB) 41 that serves as a dictionary storing unit storing therein a dictionary that is meta data and defines schemas (a row of properties) including restrictions that are applied to a process of instance data description; an error DB 42; a dictionary change rule DB 43 that serves as a rule storing unit; a knowledge describing instance data DB 44 that serves as an instance data-description knowledge storing unit; a dictionary version control rule DB 45 that serves as a version control rule storing unit; a process record DB 46 that serves as a process record storing unit; and a change proposal for dictionary DB 47.

Also, by following the meta data management program, the server 1 includes: a data error detecting unit 51 that functions as an error detecting unit; a dictionary change proposal presenting unit 52 that functions as a suggestion presenting unit; a change proposal processing unit 53 that functions as a suggestion processing unit; a dictionary change proposal receiving unit 54 that functions as a suggestion receiving unit; a user management unit 55 that manages identifiers of instance data editors; an error knowledge detecting unit 56; and a dictionary change notifying unit 57.

Next, each of these functional units will be explained in detail.

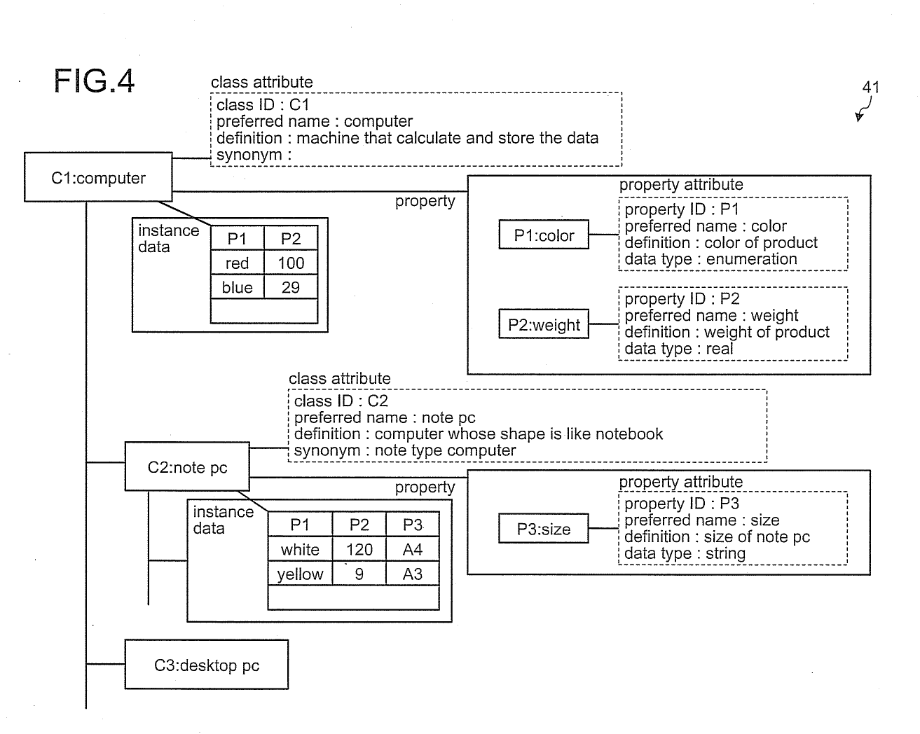

First, the dictionary DB 41 will be explained. FIG. 4 is a schematic drawing of an example of a dictionary. As shown in FIG. 4, the dictionary stored in the dictionary DB 41 is made up of categories (i.e., classes) and attributes (i.e., properties) that are necessary when the product data is written. The classes have a hierarchical structure. Each of the classes is characterized with the properties that constitute the class. According to the present embodiment, properties that are defined in an upper class are inherited to each of its subordinate classes. Further, the classes and the properties respectively have class attributes and property attributes (hereinafter, “attributes”) with which the classes and the properties are characterized. For example, the attributes of a property include “the name”, “the definition”, “synonyms”, “the data type”, and “the value format”. By using such a dictionary, instance data (i.e., the actual product data) is created while the properties defined in the classes are used as the schemas. In other words, it is assumed that the instance data editor is able to write and input the instance data (i.e., the actual product data) according to the dictionary obtained from the server 1 via the instance data editor terminal 32.

In the explanation of the present embodiment, the instance data are also shown in FIG. 4 so that the structure can be explained more easily; however, dictionaries do not usually include instance data. Also, dictionaries do not necessarily have to include classes (although a dictionary in PLIB data model has one or more classes if it has properties). In other data models, some dictionaries consist of only properties. It is sufficient if each of the dictionaries includes at least properties and attributes (e.g., the definition, the name, and the data type) for defining each of the properties.

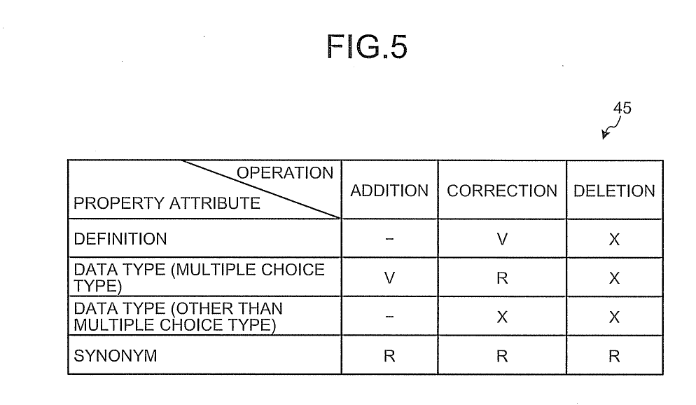

The dictionary version control rule DB 45 is a database that stores therein dictionary version control rules each of which describes the effect that will be made by a change in the dictionary elements (e.g., the classes, the properties). In FIG. 5, an example of a set of dictionary version control rules that is applicable to the PLIB data model is shown. The PLIB data model has versions and revisions for each of the dictionary elements so that the editions can be managed. In this investigation, the word “version” means both of them generally. The dictionary elements are allowed to be changed as long as there is no effect on the instance data. In other words, deleting any of the properties is prohibited because there is a possibility that the instance data may have been created by using the properties. Also, changing the data types is prohibited in principle, except that it is acceptable to add enumeration values when the data type is an enumeration type. Further, there are other rules such as a change in the definitions is responded to by changing the version, whereas an addition of a synonym is responded to by adding a revision. In FIG. 5, some of such dictionary version control rules are shown. In FIG. 5, “V” denotes changing the version; “R” denotes changing the revision; “X” indicates that the action is prohibited; and “-” indicates that the combination corresponds to a pattern that is unlikely to occur. The system used for managing the editions and the attributes may vary depending on the data model being used as the target. Thus, the dictionary version control rules can be defined so as to be suitable for each data model being used.

The dictionary change rule DB 43 is a database that stores therein dictionary change rules each of which defines, in the manner of a rule, providing of an annotation in correspondence with an error pattern that is found during the instance data description, the annotation being a piece of knowledge that is helpful when the dictionary is improved or when an instance data is written. Examples of the change proposal rules are shown in Tables 1 to 5 below. Shown in Tables 1 to 5 are processes related to data-type errors of the properties that are applicable to the example using the PLIB data model. The degrees of the effects that will be made on the dictionary are indicated based on the definitions in the PLIB; however, the degrees of the effects are written for the sake of convenience in the explanation and may vary. Also, the degrees of the effects that will be made on the dictionary and the available data types may vary depending on the model being used. In Tables 1 to 5, “Change proposal” indicates a change proposal rule; “Pattern of Change” indicates what change will be made on what attribute of the dictionary elements; “Error instance data Usability” indicates whether it is possible to use (Yes: Y) or not (No: N) the instance data that currently has an error without modifying it, if the dictionary happens to be updated according to the change proposal rule; “Degree of Effect on Dictionary” indicates the effect that will be made by a change in the dictionary and is obtained based on the dictionary management rules stored in the dictionary-version control rule DB 45. As for “Error instance data Usability”, when the dictionary has been improved in the case where the value is “Yes: Y”, the Instance data editor terminal 32 used by the instance data editor who has caused the error is notified, so that the information is helpful for the update of the instance data.

### (1) When the Data Type Is an Enumeration Type

For example, in the case where the specifics of an error are indicated as “an enumeration value {EJ} that is not defined as one of the enumeration values has been input for a property {P}”, change proposals as shown in Table 1 are presented.

TABLE 1

| | | Pattern of | Error | |
|---|---|---|---|---|
| | | Change | Instance | Degree of |
| | | (Changed | data | Effect on |
| ID | Change proposal | Attribute) | Usability | Dictionary |
| 1 | If there is a similar | knowledge | N | 0: No |
| | enumeration value {S}, | describing | | effect |
| | then the annotation | instance | | |
| | should include an | data | | |
| | instruction indicating | | | |
| | that, when the user | | | |
| | wishes to input {E}, | | | |
| | {S} should be | | | |
| | selected. | | | |
| 2 | If there is a similar | Synonym of | N | 1: |
| | enumeration value {S}, | enumeration | | Revision |
| | then {E} should be | value | | update |
| | added as a synonym of | | | |
| | the enumeration value | | | |
| | {S}. | | | |
| 3 | A note should indicate | Note | N | 1: |
| | how to treat {E}. | | | Revision |
| | | | | update |
| 4 | A remark should | Remark | N | 1: |
| | indicate how to treat | | | Revision |
| | {E}. | | | update |
| 5 | The enumeration value | Addition | Y | 2: Version |
| | {E} should be added. | of an | | update |
| | | enumeration | | |
| | | value | | |

### (2-1) When the Data Type Is a Numerical Value Type

For example, in the case where the specifics of an error are indicated as “the number of digits is excessive”, change proposals as shown in Table 2 are presented.

TABLE 2

| | | Pattern of | Error | |
|---|---|---|---|---|
| | | Change | Instance | Degree of |
| | | (Changed | data | Effect on |
| ID | Change proposal | Attribute) | Usability | Dictionary |
| 1 | An instruction should be | knowledge | N | 0: No |
| | added to the annotation | describing | | effect |
| | to instruct that the | instance | | |
| | number should be rounded | data | | |
| | off or the fractions in | | | |
| | the excessive digit | | | |
| | should be omitted. | | | |
| 2 | A note should indicate | Note | N | 1: |
| | how to treat {E}. | | | Revision |
| | | | | update |
| 3 | A remark should indicate | Remark | N | 1: |
| | how to treat {E}. | | | Revision |
| | | | | update |
| 4 | The number of digits | Value | Y | 2: Version |
| | should be increased. | format | | update |

### 2-2) When the Data Type Is a Numerical Value Type

For example, in the case where the specifics of an error are indicated as “a character string has been input although the data type is a numerical value type”, change proposals as shown in Table 3 are presented.

TABLE 3

| | | Pattern of | Error | |
|---|---|---|---|---|
| | | Change | Instance | Degree of |
| | | (Changed | data | Effect on |
| ID | Change proposal | Attribute) | Usability | Dictionary |
| 1 | An instruction on how to | knowledge | N | 0: No |
| | write input data should | describing | | effect |
| | be added to the | instance | | |
| | annotation (e.g., You | data | | |
| | don't need to write the | | | |
| | unit; or The smallest | | | |
| | value should be input). | | | |
| 2 | A new property {P} of | Data type | Y/N | 3: Will |
| | which the data type is a | change; | | cause a |
| | character string type | New | | change in |
| | should be created so | property | | the |
| | that the data is | | | instance |
| | transferred from {P}. | | | data |

### (3) When the Data Type Is a Character String Type

For example, in the case where the specifics of an error are indicated as “there was a violation related to restricted characters”, change proposals as shown in Table 4 are presented. The restrictive condition is indicated as {C}. It is assumed that the example identified with the ID “1” in Table 4 below are prepared in a plurality of patterns for different types of errors.

TABLE 4

| | | Pattern of | Error | |
|---|---|---|---|---|
| | | Change | Instance | Degree of |
| | | (Changed | data | Effect on |
| ID | Change proposal | Attribute) | Usability | Dictionary |
| 1 | An instruction on how | knowledge | N | 0: No |
| | to write input data | describing | | effect |
| | should be added to the | instance | | |
| | annotation (e.g., You | data | | |
| | cannot use 1-byte | | | |
| | Katakana characters; | | | |
| | The input should start | | | |
| | with http://). | | | |
| 2 | A remark should | Remark | N | 1: |
| | indicate the | | | Revision |
| | restrictive condition | | | update |
| | {C}. | | | |
| 3 | A note should indicate | Note | Y | 1: |
| | the restrictive | | | Revision |
| | condition {C}. | | | update |
| 4 | The restrictive | Restriction | Y | 2: Version |
| | condition {C} is | | | update |
| | unnecessary and should | | | |
| | therefore be deleted. | | | |
| 5 | A property {P} of which | Restriction | Y/N | 3: New |
| | the data type is a | change; New | | |
| | character string type | property | | |
| | and that does not have | | | |
| | the restrictive | | | |
| | condition {C} should be | | | |
| | newly created. | | | |

### (4) When the Data Type Is a Class Reference Type

The data type is a “class reference type” (so we call “class instance type” in PLIB data model) provides a reference (i.e., link) to another class in a dictionary. This data type is used for, for example, describing component parts. In a dictionary, (an identifier for) a class being a reference destination is defined as the data type of a property. In an instance data, we further specify a lower class of the reference destination class defined in the data type and plural pair of a property and its value. With this arrangement, when a class-reference type property is used, it is possible to refer to the instance data that belongs to the reference destination class.

For example, let us discuss a situation in which the specifics of an error are indicated as “the reference destination class {CC} that is specified in the instance data is not one of the child classes of the reference destination class {DC} that is defined in the dictionary”. As shown in Table 5 below, the change proposals identified with the IDs “1”, “2”, and “3” each provide a help so as to make it possible to write a correct reference destination class. Also, as shown in Table 5 below, the change proposal identified with the ID “4” suggests that the data pattern should be changed so that an upper class for both DC and CC that also satisfies the reference destination class {CC} specified in the instance data should be newly defined in the dictionary as a reference class. In addition, as shown in Table 5 below, the change proposal identified with the ID “5” suggests that a new property of which the reference destination class is {CC} may be defined. The change proposal s identified with the IDs “1”, “2”, and “3” refer to the processes that are performed in the case where the dictionary editor has judged that {CC} is an error, whereas the change proposals identified with the IDs “4” and “5” refer to the processes that are performed in the case where the dictionary editor has judged that the dictionary should be improved in such a manner that the description of {CC} is also acceptable. In Table 5 below, the notation “subclasses {C1}” denotes all the classes that are positioned below the class C1. The notation “superclass {C1, C2}” denotes the class that is positioned the lowest among the classes that are positioned above both C1 and C2.

TABLE 5

| | | Pattern of | Error | |
|---|---|---|---|---|
| | | Change | Instance | Degree of |
| | | (Changed | data | Impact on |
| ID | Change proposal | Attribute) | Usability | Dictionary |
| 1 | /* All the classes below | knowledge | N | 0: No |
| | the reference | describing | | impact |
| | destination class should | instance | | |
| | be enumerated in an | data | | |
| | annotation and presented | | | |
| | to the instance data | | | |
| | editor.*/ | | | |
| | An annotation should be | | | |
| | written instructing that | | | |
| | a class specified as a | | | |
| | reference destination | | | |
| | should be one of the | | | |
| | child classes of {DC} | | | |
| | expressed as “subclasses | | | |
| | {DC}”. | | | |
| 2 | A remark should indicate | Remark | N | 1: |
| | that a class specified | | | Revision |
| | as a reference | | | update |
| | destination should be | | | |
| | one of the child classes | | | |
| | of {DC} expressed as | | | |
| | “subclasses {DC}”. | | | |
| 3 | A note should indicate | Note | N | 1: |
| | that a class specified | | | Revision |
| | as a reference | | | update |
| | destination should be | | | |
| | one of the child classes | | | |
| | of {DC} expressed as | | | |
| | “subclasses {DC}”. | | | |
| 4 | The reference | Data type | Y | 2: Version |
| | destination class in the | | | update |
| | dictionary should be | | | |
| | changed to superclass | | | |
| | {DC, CC}. | | | |
| 5 | A new property {P} of | Data type | N/Y | 3: New |
| | which the reference | change; | | |
| | destination class is | New | | |
| | {CC} should be created. | property | | |

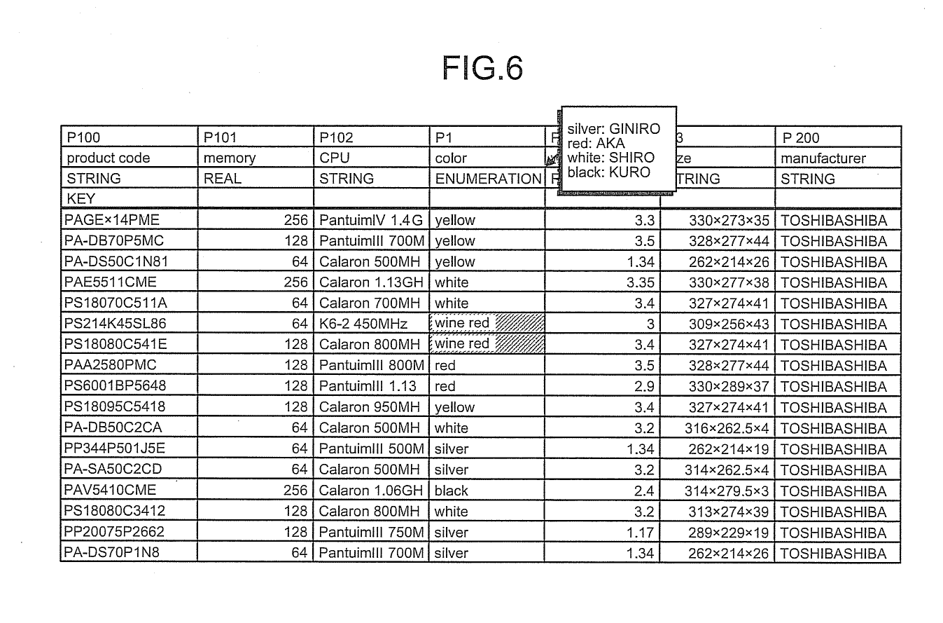

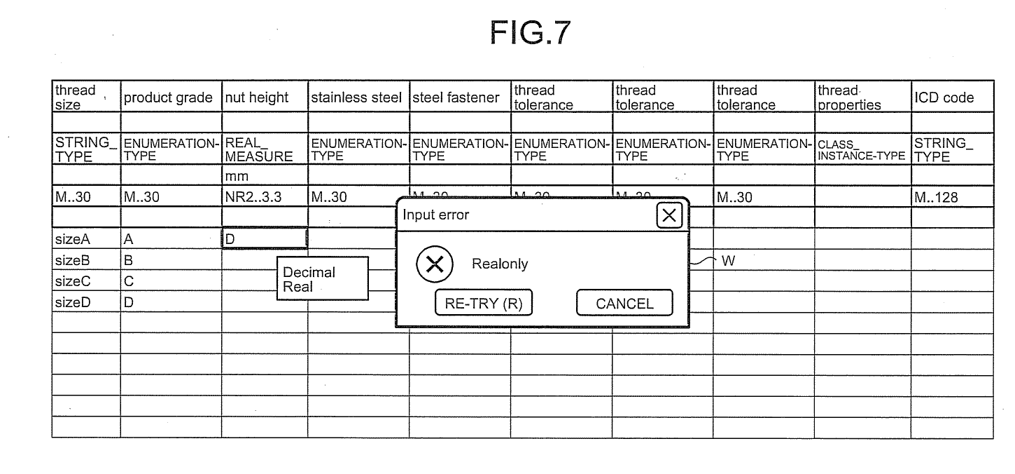

The data error detecting unit 51 detects an error out of an instance data that has been input by the instance data editor via the Instance data editor terminal 32 according to the dictionary stored in the dictionary DB 41, based on the restrictions (e.g., the data type, the keys, and the requirements) that are defined in the dictionary. The specifics of the error are returned to the instance data editor via the Instance data editor terminal 32. The instance data editor corrects the instance data properly on the Instance data editor terminal 32. In FIGS. 6 and 7, examples are shown in which a detected error is displayed on or notified to the Instance data editor terminal 32 used by the instance data editor, after the data error detecting unit 51 has detected the error. In the example shown in FIG. 6, occurrence of an error is indicated by changing the background of the cells in the situation where the input value “wine red” is not one of the enumeration values while the data type is an enumeration type. In the example shown in FIG. 7, a violation is indicated by displaying a pop-up window W in the situation where a value “D” has been input while the data type is a real-number value type. These examples of displaying or notifying errors have conventionally been used in commonly-used catalog systems.

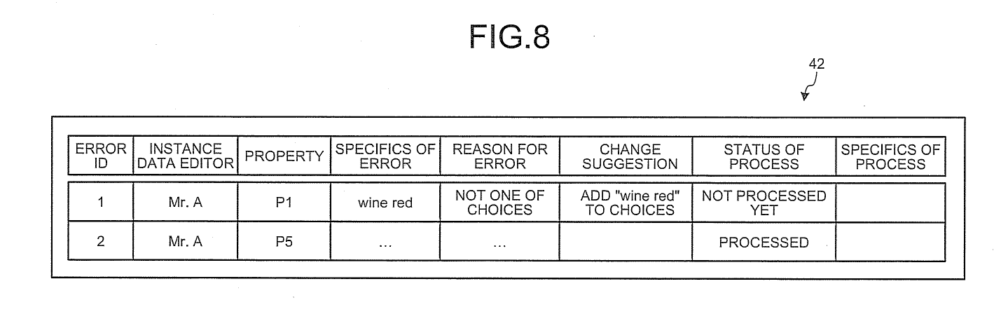

In addition, the data error detecting unit 51 records the specifics of the error that has been detected into the error DB 42. In FIG. 8, examples of the error DB 42 and the process record DB 46 are shown. In the example shown in FIG. 8, the following elements are recorded for each of the errors: an error ID; an identifier of the instance data editor managed in the user management unit 55; the property in which the error has been detected; the specifics of the error; the reason for the error; a change proposal; the status of the process; and the specifics of the process. In FIG. 3, for the sake of convenience in the explanation, the error DB 42 and the process record DB 46 are configured so as to be two databases; however, it is acceptable to manage the data by using only one database because one process result corresponds to one error.

As for errors of the same type corresponding to mutually different properties, an arrangement is acceptable in which a search is conducted in the process record DB 46 so that the error is brought into correspondence with a process that was selected last time or a process that has been selected the largest number of times.

Next, let us discuss a situation in detail in which an input error has occurred while the data type is an enumeration type, as shown in FIG. 6. Let us assume that, as shown in FIG. 6, for the property “P1: color” of which the data type is an enumeration type, the enumeration values are defined as “silver”, “red”, “white”, and “black” in the dictionary. When the instance data editor has input “wine red” as a value of P1 via the Instance data editor terminal 32, because “wine red” is not defined as one of the enumeration values for Pl, the data error detecting unit 51 recognizes that an input error has occurred. The data error detecting unit 51 notifies the instance data editor that the input error has occurred by changing the background of the cells, as shown in FIG. 6. The instance data editor recognizes that the input error has occurred and makes a correction according to the instruction. In addition, the data error detecting unit 51 records, into the error DB 42 and the process record DB 46, the identifier of the instance data editor managed in the user management unit 55 and the value of the error “wine red” as an error for P1.

At a predetermined point in time, the dictionary change proposal presenting unit 52 obtains the specifics of the error (e.g., an “enumeration value error”) that are stored in the error DB 42 and one of the dictionary change rules that have been described in the dictionary change rule DB 43 that corresponds to the specifics of the error. The dictionary change proposal presenting unit 52 creates one or more dictionary change proposals that are suitable for the actual specifics of the error and stores the created dictionary change proposals into the change proposal for dictionary DB 47. Also, the dictionary change proposal presenting unit 52 reads the dictionary change proposals from the change proposal for dictionary DB 47 and presents the dictionary change proposals onto the dictionary editor terminal 31 used by the dictionary editor. In this situation, the predetermined point in time may be one of the following: once every year, once every hour, when a new error has been stored, when an error having a high level of importance has been stored, and when the dictionary editor triggered it. To create the change proposals, it is acceptable to use the status of the dictionary elements in another dictionary included in the dictionary so as to derive relationships of synonymous terms and the like. According to the dictionary change proposals presented on the dictionary editor terminal 31, the dictionary editor chooses one of the following: to record the error into the knowledge describing instance data DB 44 as an annotation and an example of error; to change the dictionary; and not to make any change.

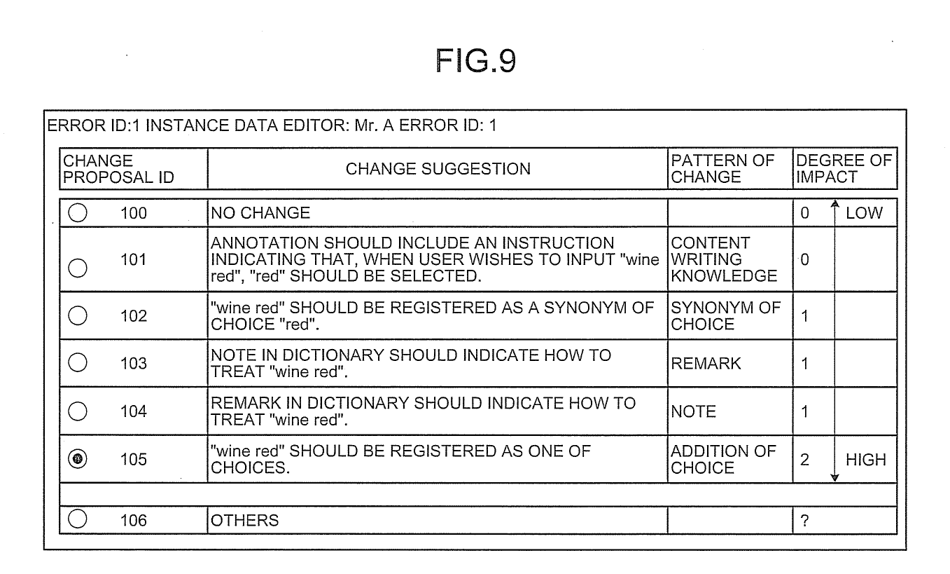

For example, in the dictionary change rule DB 43, the dictionary change rules that correspond to an “enumeration value error” are as shown in Table 1. Table 1 uses the dictionary data model of ISO 13584-12 as an example. The degrees of the effects that will be made on the dictionary by the changes are based on the definitions in the ISO standard. For example, the attributes (e.g., the name, synonyms, abbreviated names, the data type, and the definition of a property) that serve as definition elements of a property may vary according to the data model being used. Thus, the change proposal rules may also vary according to the data model being used. Also, the effect that will be made on the dictionary by a change in the attributes may vary according to the data model being used. Examples of the dictionary change proposals that are presented to the dictionary editor according to the change proposal rules are shown in FIG. 9.

In the examples shown in FIG. 9, in correspondence with each of the change proposal IDs, a change proposal, a pattern of the change, and a degree of the effect that will be made on the dictionary are presented. The change proposal identified with the ID 102 in FIG. 9 shows that a search has been conducted for a replacement in the list of the enumeration values having the correct values with respect to the error value “wine red” and that “red” has been obtained as a result of the search. It is possible to understand that “wine red” and “red” have a synonymous or similar relationship based on the relationships between names and their synonyms that are defined in the dictionaries stored in the dictionary DB 41 or any other terminology databases.

After that, as shown in FIG. 9, to select one of the dictionary change proposals presented on the dictionary editor terminal 31 (e.g., ID 105: “‘wine red’ should be registered as one of the enumeration values”), the dictionary editor operates the corresponding one of the radio buttons via the input unit 8. The dictionary change proposal that has been selected through the operation is recorded as a change proposal into the process record DB 46 or the error data stored in the error DB 42. For any of the properties, in the case where an error that has once been processed has occurred again, the error will be recorded into the error DB 42, but will not be presented by the dictionary change proposal presenting unit 52, because the error has already been processed (i.e., a synonymous name has already been added). However, in the case where the same error occurs frequently, a change proposal may be presented again on the assumption that the change was not sufficient.

According to the present embodiment, the dictionary change proposals are displayed together with the degrees of effects that will be made on the dictionary. Thus, the dictionary editor is able to improve the dictionary while comparing the effects with the specifics of the errors. Generally speaking, the smaller the effect made on the dictionary is, the smaller the effect made on the existing instance data is. Thus, the dictionary editor tends to select a dictionary change proposal that has a lower degree of effect on the dictionary.

Another arrangement is acceptable in which the dictionary change proposals described above are presented in ascending order of the degree of the effect that will be made on the dictionary. When a big change such as changing the data type is made on the dictionary, it is not possible to respond to the change by upgrading the version of the dictionary element, and it is necessary to define a new dictionary element. As for dictionaries that are currently used with instance data, it is desirable to be able to keep using the existing instance data, and it is preferable to define as few new dictionary elements as possible. Accordingly, the dictionary change proposals are displayed while the degrees of the effects are determined in the following order (see FIG. 9): a process to present an annotation or an error example in advance; a process that only requires an update of the revision; a process that only requires an update of the version; and a process that requires a new dictionary element.

Further, in the case where a change proposal has been made for a dictionary element that is similar to another dictionary element for which a change proposal has previously been made, an arrangement is acceptable in which the dictionary change proposal presenting unit 52 conducts a search in the process record DB 46 for the process that was selected by the dictionary editor in the past and presents the dictionary change proposals while giving a higher priority to the example in the past by adding the information of the result of the search to the dictionary change proposals.

In the case where the dictionary editor has judged that there is no dictionary change proposal to be implemented among the ones that have been presented by the dictionary change proposal presenting unit 52 onto the dictionary editor terminal 31, it is acceptable for the dictionary editor to create a new dictionary change rule or a new change proposal.

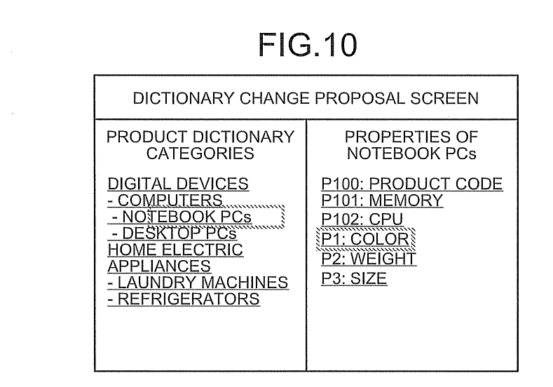

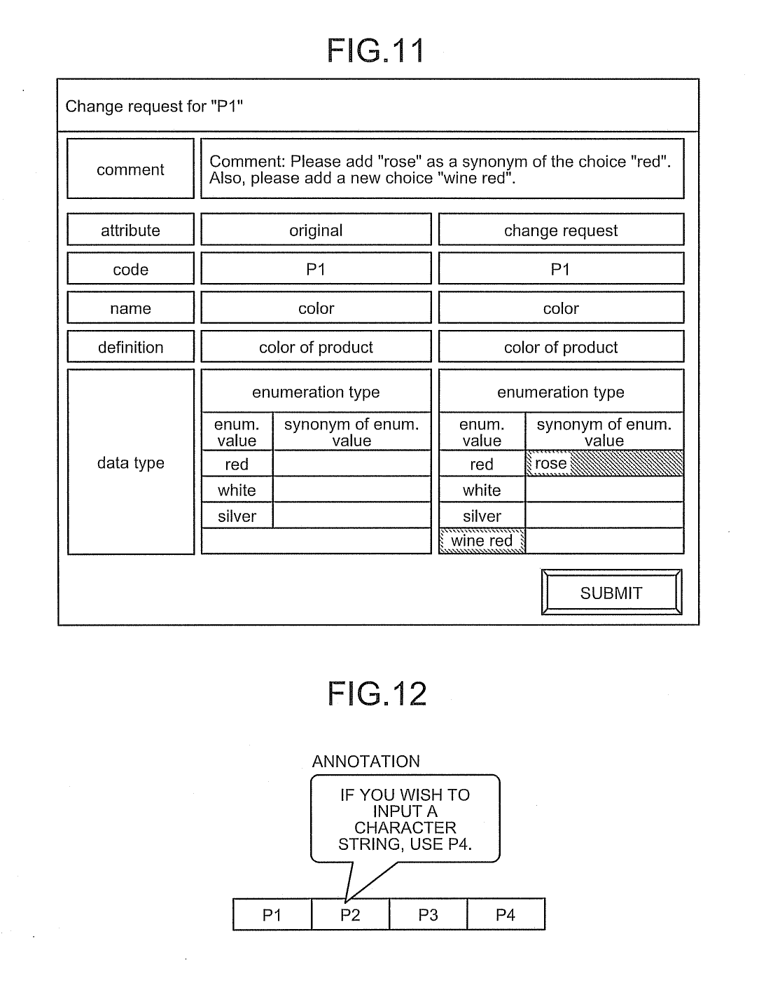

When the data error detecting unit 51 has detected an error, the dictionary change proposal receiving unit 54 receives the dictionary change proposals that have been made by the instance data editor via the Instance data editor terminal 32 with respect to the detected error. Shown in FIGS. 10 and 11 are examples of dictionary change proposal screens displayed on the dictionary editor terminal 31 after the dictionary change proposals have been received from the instance data editor. The dictionary change proposal screen shown in FIG. 10 is a screen on which the instance data editor selects one of the properties for which a dictionary change proposal is to be made. On the left-hand side of the screen shown in FIG. 10, the instance data editor selects a product category. On the right-hand side of the screen shown in FIG. 10, the properties that are defined for the selected product category are displayed. The dictionary editor selects a property out of the displayed properties. Subsequently, a screen as shown in FIG. 11 is displayed so that it is possible to input what will be changed for which one of the attributes of the property (e.g., the name, the definition, or the data type). On the screen shown in FIG. 11, with respect to the property P1 that has been selected, a suggestion is made that “rose” should be added as a synonymous name for the enumeration value “red”, and also that a new enumeration value “wine red” should be added.

The dictionary change proposal receiving unit 54 stores the dictionary change proposal that has been received as described above into the change proposal for dictionary DB 47. At a predetermined point in time, the dictionary change proposal from the instance data editor that has been stored in the change proposal for dictionary DB 47 is presented by the dictionary change proposal presenting unit 52 onto the dictionary editor terminal 31 used by the dictionary editor. In this situation, the predetermined point in time may be one of the following: once every year, once every hour, and when a new dictionary change proposal has been received. The dictionary change proposal presented on the dictionary editor terminal 31 is processed in the same manner as the change proposal that has been made based on an error as described above.

In the case where the dictionary editor has defined a new dictionary change rule, the change proposal processing unit 53 additionally stores the newly-defined dictionary change rule into the dictionary change rule DB 43 so that the newly-defined dictionary change rule can be used when the dictionary change proposals are presented next time or later. Also, based on a dictionary change plan that has been selected or created by the dictionary editor in response to the dictionary change proposal, the change proposal processing unit 53 makes a change in the dictionary DB 41 or adds an annotation to the knowledge describing instance data DB 44 according to the dictionary version control rules. When a change is made in the dictionary DB 41, the version and the revision of the dictionary are also changed according to the version control rules defined in the dictionary-version control rule DB 45. In addition, the change proposal processing unit 53 records the error and the dictionary change proposal that has been selected or created for the error into the process record DB 46.

According to the process performed by the change proposal processing unit 53, the error knowledge detecting unit 56 obtains the knowledge that has not been put into the dictionary but has adherently been provided and is required in the instance data description, such as annotations, comments, error examples, from the knowledge describing instance data DB 44 and displays the obtained knowledge onto the Instance data editor terminal 32 when the instance data editor writes instance data, as shown in FIG. 12.

When the dictionary has been updated at a point in time, the dictionary change notifying unit 57 notifies the instance data editor as to which one of the errors that were caused by the instance data editor in the past is no longer an error because the dictionary has been updated, based on the process record DB 46 and the error DB 42. As a result, the instance data editor is able to rewrite the instance data in such a manner that the instance data better complies with the actual circumstances.

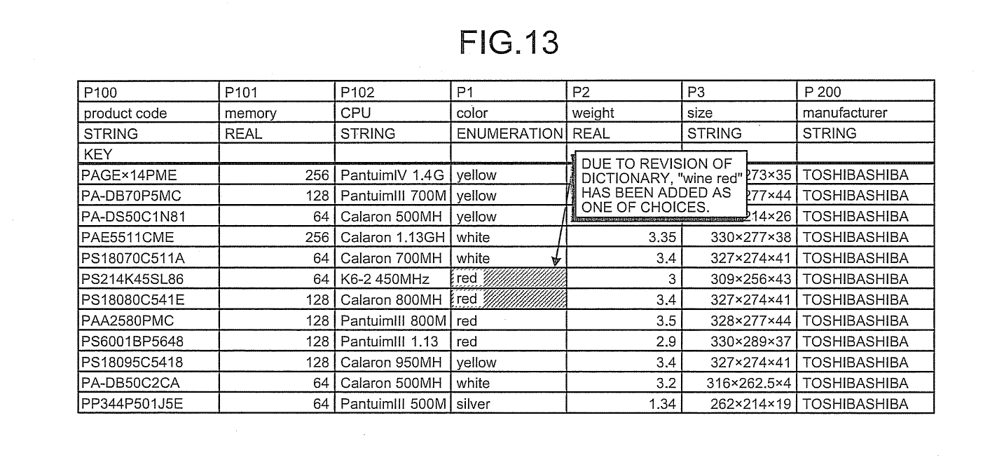

Shown in FIG. 13 is an example of a screen by which the instance data editor is notified as to which one of the errors that were caused by the instance data editor in the past is no longer an error because the dictionary has been updated. In the cells of which the background is shown differently in FIG. 13, the instance data editor had tried to input “wine red” before, but an error occurred because “wine red” was not one of the enumeration values at that point in time, and the instance data editor therefore corrected the input so as to read “red”. As explained above, in the case where the dictionary editor has performed the operation so as to select the suggestion “‘wine red’ should be registered as one of the enumeration values” identified with ID 105 as shown in FIG. 9, and the dictionary stored in the dictionary DB 41 has been updated so that “wine red” is registered as one of the enumeration values, the screen notifies the instance data editor that it is now possible for him/her to change “red” to “wine red” as he/she previously wanted to input. In other words, although the instance data editor had previously had to change the value of P1 from “wine red” to “red” because the data error detecting unit 51 detected “wine red” as an error, when the dictionary stored in the dictionary DB 41 has been improved so that “wine red” is one of the enumeration values, it is now possible for the instance data editor to change the value of P1 from “red” to “wine red”. Thus, according to the present embodiment, it is possible to naturally collect intentions and requests of the instance data editor and have them reflect in the data.

Because instance data editors rarely browse the instance data that they edited in the past, an arrangement is acceptable in which the instance data editor is notified, by e-mail or the like, that the dictionary has been revised and that there is a possibility that the instance datas created in the past may be corrected.

At the point in time when the instance data editor is notified of an error, he/she makes a correction in units of inputs of instance data. Thus, the same errors in one property are corrected all at once, as long as there is no misunderstanding again.

Another arrangement is also acceptable in which, as for the instance data errors that are caused by the instance data editor, the number of times the data error detecting unit 51 has detected an instance data error is tallied for each of the properties. It is effective to tally the number of times an instance data error is detected for each of the properties because it is often the case that an instance data editor creates a large number of instance data in a mechanical fashion. It is safe -to say that an error that is caused by misinterpretation of a property occurs only once. Needless to say, another arrangement is acceptable in which the number of times an instance data error is detected is stored into the error DB 42. By tallying the number of times an instance data error is detected, it is possible to conjecture that an instance data editor who has an especially high ratio of errors may have a problem in his/her capability of understanding (i.e., he/she does not have specialized knowledge). Accordingly, an arrangement is acceptable in which the dictionary change proposal presenting unit 52 puts a mark to each of the dictionary change proposals that have been made by such an instance data editor, so as to indicate that the instance data editor is a user having a high rate of causing errors while errors are presented. By indicating that the instance data editor is a user having a high rate of causing errors, it is possible to allow the dictionary editor to judge more carefully whether the errors should be reflected in the change of the dictionary.

Next, from the processes performed by the functional elements described above, the procedures in the instance data editing process and the dictionary change proposal presenting process will be explained.

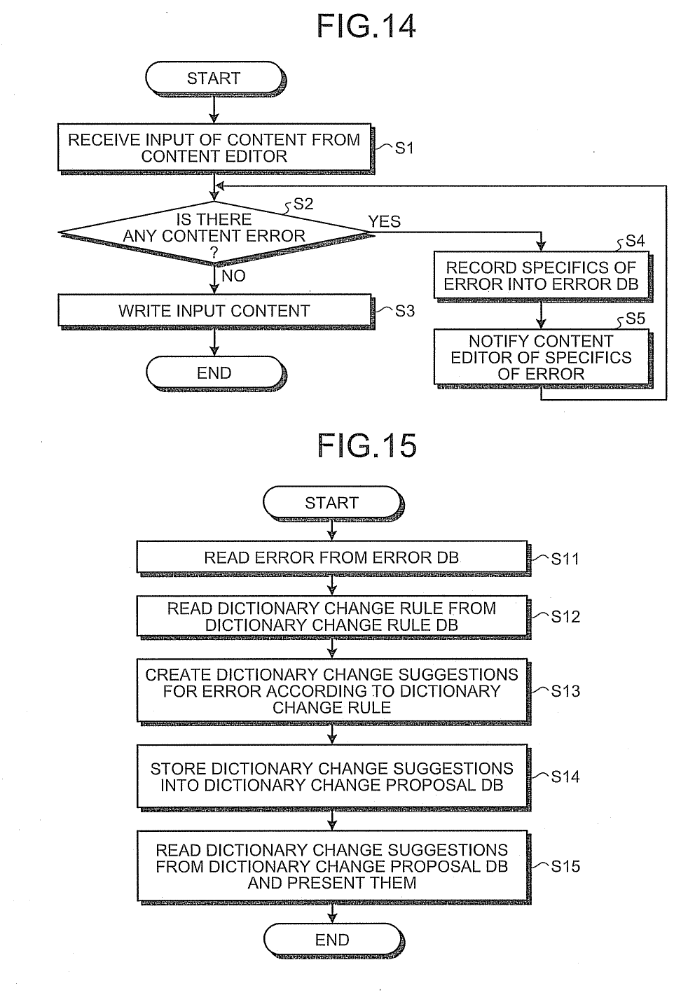

First, the instance data editing process will be explained with reference to the flowchart in FIG. 14. As shown in FIG. 14, when an input of an instance data (i.e., the actual product data) provided by an instance data editor according to the dictionary stored in the dictionary DB 41 has been received via the Instance data editor terminal 32 (step S1: the receiving unit), the data error detecting unit 51 checks the instance data that has been input by the instance data editor so as to see whether there is any error based on the restrictions (e.g., the data type, the keys,, and the requirements) that are defined in the dictionary (step S2).

In the case where the data error detecting unit 51 has judged that there is no error (step S2: No), the instance data that has been input is written (step S3), and the process is ended.

On the other hand, in the case where the data error detecting unit 51 has judged that there are one or more errors (step S2: Yes), the data error detecting unit 51 records the specifics of the errors that have been detected into the error DB 42 (step S4). The data error detecting unit 51 also returns the specifics of the errors to the instance data editor via the Instance data editor terminal 32 (step S5), and the process returns to step S1. The instance data editor refers to the specifics of the errors that have been returned and corrects the instance data properly on the Instance data editor terminal 32.

Next, the dictionary change proposal presenting process will be explained with reference to the flowchart in FIG. 15. As shown in FIG. 15, at a predetermined point in time, the dictionary change proposal presenting unit 52 reads the specifics of an error (e.g., an enumeration value error) from the error DB 42 (step S11), and also reads one of the dictionary change rules that corresponds to the specifics of the error from the dictionary change rule DB 43 (step S12). The dictionary change proposal presenting unit 52 then creates dictionary change proposal s according to the dictionary change rule that is suitable for the actual specifics of the error (step S13) and stores the dictionary change proposals that have been created into the change proposal for dictionary DB 47 (step S14). After that, the dictionary change proposal presenting unit 52 reads the stored dictionary change proposals from the change proposal for dictionary DB 47 and presents the read dictionary change proposals onto the dictionary editor terminal 31 used by the dictionary editor (step S15).

As explained above, according to the present embodiment, in the case where the specifics of an error have been detected out of an instance data -that has been received by the receiving unit via the Instance data editor terminal and that does not satisfy the restrictions being applied to the instance data description and being defined in the dictionary that is meta data, the dictionary change proposals that have been created based on the specifics of the errors and suggest the changes that can be made on the dictionary are presented onto the dictionary editor terminal, based on the dictionary change rules each of which defines, in the manner of a rule, a change that can be made on the dictionary in correspondence with an error pattern that is found during the instance data description. It is therefore possible to eliminate the disparity between the instance data editor and the dictionary editor and to improve the quality of the instance data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A meta data management apparatus comprising:
a dictionary storing unit that stores a dictionary that is meta data defining a schema including a restriction of an instance data description;
a rule storing unit that stores dictionary change rules each of which defines, in a manner of a rule, a change of the dictionary in correspondence with an error pattern of the instance data description;
a receiving unit that receives an instance data described according to the schema via an Instance data editor terminal used by an editor of the instance data;
an error detecting unit that detects specifics of an error when the instance data received by the receiving unit does not satisfy the restriction of the instance data description; and
a suggestion presenting unit that presents a change proposal to a dictionary editor terminal used by a dictionary editor, the change proposal suggesting the change of the dictionary created based on the specifics of the error and one of the dictionary change rules corresponding to the specifics of the error.

2. The apparatus according to claim 1, wherein
the rule storing unit stores the dictionary change rules each of which defines, in the manner of a rule, a provision of error knowledge that is knowledge helpful while an instance data is described in correspondence with the error pattern of the instance data description, in addition to the change of the dictionary, and
the suggestion presenting unit creates the change proposal suggesting one of the change of the dictionary and the provision of the error knowledge.

3. The apparatus according to claim 1, further comprising a version control-rule storing unit that stores a version control rule that describes effects each of which is made by a change in the dictionary, wherein
each of the dictionary change rules stored in the rule storing unit also describes one of the effects on the dictionary, and
the suggestion presenting unit presents a degree of one of the effects together with the change proposal, on the dictionary editor terminal.

4. The apparatus according to claim 1, further comprising a suggestion processing unit that receives, via the dictionary editor terminal, a dictionary change plan selected or created by the dictionary editor in response to the change proposal, and changes what is stored in the dictionary storing unit according to a version control rule.

5. The apparatus according to claim 4, wherein when the suggestion processing unit receives a dictionary change rule that is newly defined via the dictionary editor terminal, the suggestion processing unit additionally stores the received dictionary change rule into the rule storing unit.

6. The apparatus according to claim 4, further comprising an instance data-description knowledge storing unit that stores the error knowledge, wherein
the suggestion processing unit receives, via the dictionary editor terminal, -the error knowledge as the dictionary change plan selected or created in response to the change proposal, and additionally stores the received error knowledge into the instance data-description knowledge storing unit according to the version control rule.

7. The apparatus according to claim 6, further comprising an error knowledge detecting unit that displays the error knowledge stored in the instance data-description knowledge storing unit on the Instance data editor terminal.

8. The apparatus according to claim 1, further comprising a suggestion receiving unit that receives the change proposal via the instance data editor terminal, wherein
the suggestion presenting unit presents the change proposal on the dictionary editor terminal.

9. The apparatus according to claim 1, further comprising a process record storing unit that stores a record of change processes performed on the dictionary by a suggestion processing unit, wherein
when a change proposal is made for a dictionary element that is similar to another dictionary element, the suggestion presenting unit conducts a search in the process record storing unit for a process selected in a past, and presents the change proposal while giving a higher priority to an example in the past by adding information of a result of the search to the dictionary change proposal.

10. The apparatus according to claim 1, further comprising a dictionary change notifying unit that notifies the instance data editor terminal that the specifics are no longer an error, when the specifics regarded as the error during detecting the error of the instance data becomes no longer an error due to the change of the dictionary.

11. A computer program product having a computer readable medium including programmed instructions for managing meta data, wherein the instructions, when executed by a computer, cause the computer to perform:
receiving an instance data described according to a schema that is defined in a dictionary being the meta data and includes a restriction of an instance data description, via an Instance data editor terminal used by an editor of the instance data;
detecting specifics of an error from the received instance data, when the received instance data does not satisfy the restriction of the instance data description; and
presenting a change proposal to a dictionary editor terminal used by a dictionary editor, the change proposal suggesting a change of the dictionary created from the specifics of the error, based on a dictionary change rule which defines, in a manner of a rule, the change of the dictionary corresponding to an error pattern of the instance data description.

12. A meta data management method comprising:
receiving an instance data described according to a schema that is defined in a dictionary being the meta data and includes a restriction of an instance data description, via an Instance data editor terminal used by an editor of the instance data;
detecting specifics of an error from the received instance data, when the received instance data does not satisfy the restriction of the instance data description; and
presenting a change proposal to a dictionary editor terminal used by a dictionary editor, the change proposal suggesting a change of the dictionary created from the specifics of the error, based on a dictionary change rule which defines, in a manner of a rule, the change of the dictionary corresponding to an error pattern of the instance data description.
